(19) United States
(12) Patent Application Publication
(10) Pub. No.: US 2016/0205961 A1
(43) Pub. Date: Jul. 21, 2016

(54) Continuous Process for Producing a White Cheese Preparation

(71) Applicant: DMK Deutsches Milchkontor GmbH, Zeven (DE)

(72) Inventor: Martin May, Dorentrup (DE)

(21) Appl. No.: 15/001,751

(22) Filed: Jan. 20, 2016

(30) Foreign Application Priority Data
Jan. 21, 2015 (EP) 15 151 915

(51) Int. Cl. A23C 19/076; A23C 19/064; A23C 19/097; A23C 19/024; A23C 19/05

(52) U.S. Cl. CPC A23C 19/076; A23C 19/024; A23C 19/052; A23C 19/0973; A23C 19/064

(57) ABSTRACT

A continuous process is proposed for producing a white cheese preparation, in which
(a) pasteurized milk is heated to a temperature from 80 to 95° C.,
(b) the heated milk is denatured,
(c) the denatured product is subjected to a dwell time,
(d) the resultant product is freed from the whey,
(e) the residue, optionally with addition of additives is placed into a mould with the aid of a vacuum former and finally
(f) from the mould is charged into the final packaging.

### FIELD OF THE INVENTION

The invention is in the field of cheese production and relates to an improved, and in particular continuous, process for producing white cheese.

### PRIOR ART

White cheese is a cheese without colouring matter and which has a dry mass of 40 to 60% by weight, to which is added, for preservation, 3 to 8% by weight of common salt and which has a crumbly consistency. In Europe this brine cheese is generally pressed to form cubes or blocks and is primarily used as an accompaniment to salads. In Asia, in particular in India, in contrast, white cheese, which is there termed Paneer, or Panir, primarily serves for protein supply and as an ingredient in curries; in this case, it resembles tofu in consistency and taste. Classically, Paneer is produced by curdling boiled milk by adding lemon juice, yoghurt, or vinegar and boiling again. By filtration, the whey is then separated from the solid mass which is then placed in a mould.

Industrial production does not appear much different today. For this purpose, pasteurized (vat) milk is used as starting material which is heated from 4° C. directly or indirectly to 80 to 90° C. and then is denatured at this temperature with addition of acid (citric acid, lactic acid). After a dwell time of about 8 minutes, the whey is pressed off and the remaining mass is moulded. Having reached this stage, the product is cooled, then placed in a salt bath and finally packaged.

However, industrial production has been burdened until now with a whole series of disadvantages, namely:
the products have only a short shelf life
pressing of the whey is bad for the texture of the white cheese;
subsequent introduction into the salt bath is time consuming and costly
the process proceeds only batchwise.

The object of the present invention was therefore to improve the production process for white cheese (or for Paneer or Panir) in such a manner that the above described disadvantages are overcome. In particular, the process should be configured so as to be continuous and to succeed without time-consuming introduction of the cheese mass into a brine.

### DESCRIPTION OF THE INVENTION

A first subject matter of the invention relates to a first continuous process for producing a white cheese preparation, in which
(a) pasteurized milk is heated to a temperature from 80 to 95° C.,
(b) the heated milk is denatured,
(c) the denatured product is subjected to a dwell time,
(d) the resultant product is freed from the whey,
(e) the residue, optionally with addition of additives is placed into a mould with the aid of a vacuum former and finally
(f) from the mould is charged into the final packaging.

Surprisingly, it has been found that the process according to the invention solves completely the complex formulation of the problem described at the outset. The invention relates to a continuous process which differs from the prior art, in particular, in that the product that is freed from the whey is drawn into the mould by a vacuum filler. This is a considerably gentler procedure than the pressing and likewise permits a free format selection. Preferably, extruded rods are produced that then are moulded separately.

In this procedure, it is, in addition, also possible during moulding already to add additives such as salt or spices, in such a manner that a central concern of the invention, bypassing a salt bath, becomes possible. The product therefore now need not be cooled for the salt bath, but can be packaged hot (for example at about 75° C.), which leads to the fact that the product, instead of 2 to 3 weeks, now has a shelf live of 6 to 8 weeks.

Pasteurized Milk

As starting material for the production of the white cheese preparation, pasteurized milk is used which is also termed vat milk or cheese milk. This is understood to include raw milk which, after pasteurization and fat standardization, is to be thickened for producing cheese, but also yoghurt. Since cheese production had previously been predominantly carried out in vats—which today is sometimes also still typical for the production of Parmesan—as a synonym, the term vat milk is used.

So that raw milk can be used for the production of cheese, it must correspond with legal requirements that are established in the cheese regulations. Usually, the processing starts with heating the raw milk by heat exchange using heat-exchange media with simultaneous partial heat recovery. The separation into skimmed milk, cream and separator sludge takes place in this heated state of the raw milk. In addition, the heating is carried to the point that a first thermization or pasteurization takes place. After its subsequent standardization, the standardized milk is buffered in a tank and the buffered milk withdrawn from the tank is subjected with renewed heating to a second pasteurization, in order to kill germs formed in the interim.

Preferably, however, vat milk is used which is obtained by the process. For this purpose,
(a) raw milk is subjected to a heat treatment,
(b) the heat-treated product is freed from solid constituents,
(c) the resultant intermediate product is defatted,
(d) the resultant skimmed milk is subjected to a microfiltration, and
(e) the resultant permeate is adjusted to the desired fat content by addition of an amount of the cream separated off in step (c), and the resultant standardized milk is
(f) subsequently pasteurized.

Heat Treatment.

The heat treatment of the raw milk (“microbial removal”) proceeds in total, preferably in heat exchangers, wherein, special plate heat exchangers have proved to be particularly suitable. A temperature gradient is applied to the heat exchangers which, however, is selected in such a manner that the raw milk is heated to a temperature from about 70 to 80° C., and in particular about 72 to 74° C., for a dwell time of at least 20 seconds, and at most 60 seconds, preferably about 30 seconds.

Solids Removal.

Separating off solids (“cheese dust”) and separating off the fat fraction of about 4% by weight usually proceeds in a downstream component, preferably a separator. Such components are sufficiently known from the prior art. Very widespread in the milk industry are separators from GEA Westfalia Separator GmbH, with which the two steps can be carried out separately or together (http://www.westfalia-separator.com/de/anwendungen/molkereitechnik/milch-molke.html). Corresponding components are also described, for example, in DE 10036085 C1 (Westfalia) and are very well known to a person skilled in the art, so carrying out these process steps requires no explanations, since they can be counted part of general specialist knowledge.

Microfiltration.

Microfiltration is a process for separating off material. The substantial difference between microfiltration and ultrafiltration is based in the various pore sizes and in the different membrane structure, as with the materials and the participating filter materials. Filtration through membranes having a pore size <0.1 μm is generally termed ultrafiltration, whereas filtration at pore sizes >0.1 μm is usually termed microfiltration. In both cases, these are purely physical, i.e. mechanical, membrane separation processes which operate according to the principle of mechanical size exclusion: all particles in the fluids which are larger than the membrane pores are retained by the membrane. The motive force in both separation processes is the differential pressure between feed and outlet of the filter surface, which is between 0.1 and 10 bar. The material of the filter surface can, depending on field of application, consist of stainless steel, plastic, ceramics or textiles. There are various forms of the filter elements: candle filters, flat membranes, pocket filters and hollow fibre modules that are all fundamentally suitable in the context of the present invention.

Standardization.

The cream that is to be added for standardization of the skimmed milk that is separated from the raw milk can be taken off from the cream separated off therefrom. In addition, or as an alternative, the cream that is to be added can also be withdrawn, however, from other processes, in particular from a whey processing process in which whey cream is produced. In addition, in the standardization, by means of a metered addition of protein, which, for example, is taken off from another milk processing process, the protein content can also be standardized.

Denaturation

The pasteurized milk can be denatured in a manner which is known per se, preferably in a temperature range from about 70 to about 95° C.

The denaturation can be carried out using food acids, preferably by adding from about 0.1 to about 0.5% by weight lactic acid and/or citric acid.

Alternatively, the denaturation can also be performed by adding rennet. This has the advantage that the denaturation can also be carried out in the cold, i.e. in a temperature range from about 20 to about 50° C.

Separating Off the Whey

The whey can be separated off, in principle, in a classic manner, that is to say by expression. However, this procedure is less advantageous, because the texture of the white cheese is adversely effected. Preferably, the whey is therefore separated off using what is termed a sieving belt. This is a strip of plastic, metal or textile which is provided with holes and tapers in the transport direction. The whey drips through the perforation without pressure. In this manner, an even texture of the white cheese is obtained, and in particular, the crumbliness is counter acted. At the same time, this procedure, in contrast to the pressing process, can also specifically be carried out continuously.

Preferably, the process is controlled in such a manner that, after separating off the whey, a residue is obtained which has a dry mass from about 40 to about 60% by weight, and preferably about 45 to about 55% by weight.

Shaping

The white cheese preparation which is freed from the whey and set to a defined dry mass is then shaped. According to the invention, this is performed using what is termed a vacuum former. This is taken to mean to a person skilled in the art a component in which a semisolid or pasty mass which, under standard conditions does not have sufficient flow properties, is drawn into a provided mould by applying a vacuum. These shapes are preferably rectangular patterns, in such a manner that the cheese mass is then present in the form of rods or bars which can then be further comminuted, in order finally to give, for example the known Paneer cubes. The advantage of the vacuum former is twofold: first the packaging can proceed continuously, i.e. the procedure is only interrupted briefly in order to change the pattern. Secondly, this process permits further constituents to be added to the white cheese. Such constituents include, in particular, common salt which is added in amounts of typically about 1 to about 10% by weight, and in particular about 4 to about 8% by weight—based on the product freed from whey. An even distribution of the additives in the cheese mass is achieved by the vacuum forming. Also, this is again associated with two advantages: firstly, this saves the complex salt bath, secondly, the cheese is preserved with salt, not only in the outer regions, but, owing to the improved distribution of the salt, is protected in its entirety in a lasting manner. As a result, this leads to a significant improvement in the shelf life by about 2 to 3 times.

Of course, it is likewise possible in this case also to add spices, flavourings and/or herbs to the white cheese, and in this manner produce absolutely atypical products having their own taste notes.

A final advantage of this process step is that packaging can be performed hot. If the white cheese usually first needs to be cooled to ambient temperature after shaping, before it is placed in the brine bath, in the context of the process according to the invention, the packaging can proceed directly at about 60 to about 80° C. This saves not only time and energy, but also increases the shelf life, because in this manner germ formation is avoided.

Alternative Processes

A further subject matter of the present invention relates to an alternative continuous process for producing a white cheese preparation, in which
(a) pasteurized milk can be curdled by addition of rennet,
(b) the product is heated to a temperature from 80 to 95° C., and subjected to a dwell time,
(c) the resultant product is freed from the whey,
(d) the residue, optionally with addition of additives, is placed into a mould with the aid of a vacuum former and finally
(e) from the mould is charged into the final packaging.

The alternative process differs from the first process only in that the denaturation is carried out cold with the use of rennet. Therefore, it is not a separate invention, but both processes are connected by the same inventive concept as described above.

### EXAMPLES

### Example 1

1000 l of pasteurized vat milk having a fat fraction of 45% by weight were gently preheated to 90° C. in a stainless steel tank with external heating and internal agitator. Then, 30 kg (equivalent to about 3% by weight) of lactic aid were added, which were stirred in in the course of 15 minutes. The product thus denatured was kept for a further 10 minutes at the temperature after the agitator had been switched off and then were added at a rate of 50 l/min to a continuously running sieving belt (perforation diameter: approximately 10 mm) and thus freed from the whey. A white cheese mass having a dry fraction of 52% by weight was obtained. This mass was continuously fed to a vacuum former at a temperature of still about 80° C. and there charged with common salt in an amount of about 6% by weight. The cheese mass thus treated was continuously charged into moulds and aseptically sealed at a pressure of 100 mbar and a temperature of approximately 75° C.

### Example 2

1000 l of pasteurized vat milk having a fat fraction of 45% by weight were gently preheated to 90° C. in a stainless steel tank having external heating and internal agitator. 20 kg (equivalent to about 2% by weight) of rennet were then added, which were stirred in in the course of 15 minutes. The product thus denatured was held at the temperature for a further 10 minutes after switching off the agitator and then added at a rate of 50 l/min to a continuously running sieving belt (perforation diameter: approximately 10 mm) and thus freed from the whey. A white cheese mass having a dry fraction of 47% by weight was obtained. This mass was continuously fed to a vacuum former at a temperature of still about 80° C. and there charged with common salt and hot paprika powder in an amount in each case of about 4% by weight. The cheese mass thus treated was continuously charged into moulds and aseptically sealed at a pressure of 100 mbar and a temperature of approximately 75° C.

### Example 3

1000 l of pasteurized vat milk having a fat fraction of 45% by weight, in a stainless steel tank with external heating and internal agitator, were admixed with 20 kg (equivalent to about 2% by weight) of rennet, which was stirred in in the course of 15 minutes. The product thus denatured was gently heated to 85° C. after the agitator was switched off, kept for a further 10 minutes at the temperature and then added at a rate of 50 l/min to a continuously running sieving belt (perforation diameter: approximately 10 mm) and thus freed from the whey. A white cheese mass having a dry fraction of 50% by weight was obtained. This mass was continuously fed to a vacuum former at a temperature of still about 80° C. and there charged with common salt and herb and spice paste in an amount in each case of about 4% by weight. The cheese mass thus treated was continuously charged into moulds and aseptically sealed at a pressure of 100 mbar and a temperature of approximately 75° C.

### Example 4

A vat milk pasteurized to a fat content of 45% was preheated to 90° C. using a suitable heater (plate or tube heat exchanger). Using a vortexing section inline, about 1-9 g of citric acid per 1000 g of milk was fed in dissolved form to the heated milk. The milk can optionally be cooled to 70° C. before the addition of acid for technological reasons. The curd-whey mixture obtained in this way was added to a continuously running sieving belt (perforation diameter: approximately 10 mm) and thus freed from the whey. A white cheese mass having a dry fraction of 52% by weight was obtained. This mass was continuously fed to a vacuum former at a temperature of still about 60-80° C. and there charged with common salt in an amount of about 6% by weight. The cheese mass thus treated was charged continuously into moulds at a pressure of 100 mbar and a temperature of approximately 65° C., and aseptically sealed.

1. A continuous process for producing a white cheese preparation, comprising the following steps:
(a) heating pasteurized milk to a temperature from 80 to 95° C.,
(b) denaturing the heated milk from step (a),
(c) subjecting the denatured product from step (b) to a dwell time of from about 5 to about 15 minutes,
(d) removing whey from the resultant product of step (c) using a sieving belt,
(e) placing the residue from step (d) with addition of at least one additive into a mould with the aid of a vacuum former and finally
(f) charging the product from step (e) from the mould into the final packaging at a temperature of from about 60 to about 80° C.

2. The process according to claim 1, wherein the pasteurized milk is denatured by addition of a food acid.

3. The process according to claim 2, wherein the food acid used is lactic acid or citric acid.

4. The process according to claim 2, wherein the pasteurized milk is denatured by addition of rennet.

5. The process according to claim 1, wherein the denaturation is carried out at a temperature from 80 to 95° C.

6-7. (canceled)

8. The process according to claim 1, wherein the residue of step (d) has a dry mass from about 40 to about 60% by weight.

9. The process according to claim 1, wherein in step (e), salt is added during moulding.

10. The process according to claim 9, wherein 1 to 10% by weight of salt, based on the product freed from the whey, is added.

11. The process according to claim 1, wherein in step (e) the additive is selected from the group consisting of spices, flavourings, and herbs and mixtures thereof.

12-15. (canceled)
